(19) United States
(12) Patent Application Publication
(10) Pub. No.: US 2005/0275655 A1
(43) Pub. Date: Dec. 15, 2005

(54) Visualizing multivariate data

(75) Inventors: Markus Stolze, Bern (CH); Claude Mueller, Basel (CH)

Correspondence Address: LOUIS PAUL HERZBERG, 3 CLOVERDALE LANE, MONSEY, NY, 10952, US

(73) Assignee: International Business Machines Corporation, Armonk, NY (US)

(21) Appl. No.: 11/146,492

(22) Filed: Jun. 6, 2005

(30) Foreign Application Priority Data
Jun. 9, 2004 (EP) 04405358.5

(51) Int. Cl. G06T 11/20

(52) U.S. Cl. 345/440

(57) ABSTRACT

The invention provides methods and apparatus for visualizing multivariate data being provided with attributes. It further provides systems for displaying multivariate data. A method and a system allow identification of items of interests and to increase the amount of information to be displayed in respect to the attribute mapped to the brightness visualization dimension a method is proposed for visualization of multivariate data being provided with attributes comprising the steps of: mapping a multivariate data point to a glyph; calculating a brightness value for the glyph by mapping a continuous data dimension to the glyph; and displaying the glyph based on the calculated brightness value. By further interactively adjustment the interval of interest the mapping function for calculating the brightness value could be adapted interactively depending on user settings. Such methods are suitable for intrusion detections systems and online data analysis systems.

### TECHNICAL FIELD

The invention relates to a method for visualizing multivariate data being provided with attributes. It further relates to a system for displaying multivariate data.

### BACKGROUND OF THE INVENTION

Nowadays the amount of data to be processed increases very rapidly. This increasing amount of data could be found in almost every business field, especially in the area of computer network security. However, other business fields use data bases to manage large amount of data also.

With the expansion of the Internet, electronic commerce and distributed computing, the amount of information transmitted via computer networks is continuously increasing. Such technologies have opened many new business horizons. However, they have also resulted in a considerable increase of illegal computer intrusions. That is why intrusion detection has become a rapidly developing domain.

An intrusion detection system is composed from hardware components and mostly software components. The hardware components are used for receiving, processing and displaying the so-called events. An event is a multivariate data point having multiple data dimensions or attributes. The events should be monitored for determining if an attack or if a potential intrusion has occurred. Given the current state of network intrusion detection system and event correlation technology, the monitoring of events by human specialists is vital for considerably reducing the number of false alarms that network-based intrusion detection system typically report. To perform this task as efficient and as effective as possible human operators should be supported in their tasks. One way to support operators is to provide them with a visualization of the incoming alarm events. In particular in the area of intrusion detection the events to be monitored have a lot of attributes. Not all attributes are relevant for the analysis of the occurrence of an intrusion.

Therefore it is a challenge for a monitoring operator of the intrusion detection system to spot those events that are indicators of a real security problem. In order to distinguish security problem events from “false positive” alarms, the operators of the intrusion detection system usually watch out for interesting event patterns by monitoring visualized events.

However before an event is visualized it is processed by means of a pattern detection algorithm. This pattern detection algorithm enables to detect whether an arrived event is part of a given pattern on the basis of a comparison of the attributes allocated to this given pattern and the attributes associated to the arrived event. After using that kind of pattern recognition for filtering the arriving events, the detected events are visualized or displayed.

For visualizing multivariate data each multivariate data point is represented as a glyph, wherein each attribute of interest is mapped to a visualization dimension of the glyph. These visualization dimensions are, for example, the two dimensional position of the glyph, its size, its color and its brightness.

In the field of intrusion detection or security event monitoring the arriving security events are characterized by multiple attributes including source-IP (internet address of the computer that originated the identified network traffic), target-IP (internet address of the computer the identified network traffic was sent to), alarm type (classification of the identified network traffic), and the arrival time of the event. The events mapped to the glyphs might be displayed, for example, in a scatter plot that maps source IP of an event to the X position of its associated glyph, the Y position to the alarm type and a further attribute of the event to be monitored to the brightness of the glyph.

The operator has to monitor the displayed glyphs. So there is a need to display the glyphs in such way that the operator could get a view on the events very easily without checking several monitors or representations. Comparing the displayed attributes of interest especially the attribute of the multivariate data point mapped to the brightness of a glyph can be problematic if the range of possible values is large, but the interesting differences are related to a small subinterval. The reason for this is that due to limitations of the human perceptual system only sizable differences in brightness are perceivable. Furthermore it is known that the perceived brightness of a point is a non-linear function, typically a power function, of the amount of light emitted by the source.

It is know from the article “Visual Information Seeking: Tight Coupling of dynamic query Filters with Starfield Displays” by Christopher Ahlberg and Ben Shneiderman, University of Maryland, to filter large amounts of multivariate data by using dynamic filter queries. Further a Dynamic HomeFinder query system is described. Therein the data points, which satisfy the query will be displayed. The query components realized as sliders or buttons act as filters reducing the numbers of data points left in the result set. The result is achieved by using simple Boolean combinations. The result is displayed in a map, wherein the location represents the real location of a home which satisfies the query. Also the brightness is used a visualization dimension, wherein only two values are possible to display. The result of the query is displayed using the brightness dimension values ON or OFF. Thus this dimension of the brightness is very limited to contain and visualize information.

Since the amount of data dimensions or attributes associated to a multivariate data point is large in comparison to the visualization dimensions which could be displayed, it would be very helpful to easily identify the events of interests and to display as much information as possible without overloading the display.

### SUMMARY OF THE INVENTION

Therefore it is an aspect of the present invention to provide methods, apparatus and systems allowing easily to identify multivariate data points of interests and to increase the ability to distinguish the visualized multivariate data points. It is a further aspect to increase the amount of information to be displayed in respect to the attribute mapped to a brightness visualization dimension.

In an advantageous embodiment the calculation procedure for calculating the brightness value for the glyph is determined. The calculation procedure could be adapted to different tasks by choosing a special calculation procedure. There are several kinds of calculating the brightness values. The adaptation, for example, to the human perceptual system calls for a different calculation procedure, than the adaptation to a special mapping curve used for a special monitor or display device.

According to a further advantageous embodiment the calculation of the brightness value for the glyph is performed using fuzzy technology; and/or different kinds of glyphs are used for mapping a multivariate data point to the glyph; and/or the glyphs are displayed in a circular coordinate system; and/or an event in an intrusion detection system is realized by the multivariate data points; and or limiting the range of time to be visualized.

Also, providing the visualization of the multivariate data as a service, a customer can be billed for information that is derivable from the visualization of the multivariate. This can comprise the steps of deriving customer related information from displayed glyphs; providing the customer related information to the customer; and billing or charging the customer for the provided information. Thus, the presented method can be used to provide a useful service that helps customers to identify relevant intrusions and thereby making their systems more secure. Instead of providing the customer related information to the customer an immediate action could be initiated for protecting, e.g., the costumers network.

### DESCRIPTION OF THE DRAWINGS

Advantageous embodiments of the invention are described in detail below, by way of example only, with reference to the following schematic drawings.

FIG. 1 illustrates a comparison of brightness differences between events with age ½ hour and 1 hour, when different fixed brightness mapping functions are used.

FIG. 2 shows a related Boolean mapping of brightness as provided by the “dynamic query” interactive visualization technique;

FIGS. 3a, b show two interactively specifiable brightness-mapping functions;

FIGS. 4a, b represent the difference between a mapping with adjustment of time of interest and without adjustment;

FIG. 5 illustrates a monitoring console according to the present invention;

FIG. 6 shows an alternative monitoring console according to the present invention;

FIG. 7 shows a function for mapping the brightness by specifying the exponent of a logarithmic function according to the invention;

FIG. 8 shows a combination of Boolean and logarithmic mapping function.

The drawings are provided for illustrative purpose only and do not necessarily represent practical examples of the present invention to scale.

### DETAILED DESCRIPTION OF EMBODIMENTS

The present invention provides methods, apparatus and systems allowing easily identification of multivariate data points of interests and to increase the ability to distinguish the visualized multivariate data points. It increases the amount of information to be displayed in respect to the attribute mapped to the brightness visualization dimension. The invention is based on using a continuous visualization dimension for the brightness the amount of data which could be transferred by the visualization to the monitoring operator could be increased. By mapping a multivariate data point to a glyph, calculating a brightness value for the glyph by mapping a continuous data dimension to the glyph, and displaying the glyph based on the calculated brightness value it will be achieved to increase the quality of representation of multivariate data points and to increase the amount of data to be displayed. Further by adjusting the interval of interest the multivariate data points to be compared are more spread resulting in a better adaptation to the current security monitoring task.

In a further embodiment the calculation procedure for calculating the brightness value for the glyph is determined. The calculation procedure could be adapted to different tasks by choosing a special calculation procedure. There are several kinds of calculating the brightness values. The adaptation, for example, to the human perceptual system calls for a different calculation procedure, than the adaptation to a special mapping curve used for a special monitor or display device.

The use of user settings, realized as user specified parameters, provide the possibility to parameterize the calculation procedure interactively. Thereby a user can interactively influence the visualization. If the attribute of interest to be mapped to the brightness is the time of appearance of a multivariate data point, the user can adjust the time interval to be displayed for monitoring. He or she can set an upper and a lower border of time for multivariate data points not to be displayed. Then only the multivariate data points lying between these borders are displayed.

Because of using a continuous visualization dimension for the brightness the mapping could be spread resulting in a visualization of multivariate data points having a brightness which could be differentiated more easily. By using the adjustment of the interval of interest for a certain attribute of the multivariate data points the brightness dimension could be effectively used. By combining the visualization dimension position, color, size, shape and brightness to display a set of multivariate data points there are enough possibilities to adapt the visualization and to improve the detectability or ability to distinguish the multivariate data points.

It is generally known to set borders of an interval of interest, in which multivariate data points should be displayed or not. But this kind of procedure is a “hard cut” information. By not displaying multivariate data points lying outside the borders, the connection to the total situation could be lost. Especially in the area of security monitoring it would be very helpful to interactively adjust the borders of the displayed multivariate data points and further also to adjust the kind of display in a sensitive way, having a broad degree of freedom. Especially the attributes of multivariate data points mapped to the brightness should be adapted to the human perceptual system.

According to a further embodiment the calculation of the brightness value for the glyph is performed using fuzzy technology. By adjusting the fuzzy membership function in dependence of the user settings the user or operator can affect the calculation procedure. So it is possible to create combinations of calculation procedures, wherein for a certain range of values a certain calculation procedure is applied and for a different range of values of the attributes a different calculation procedure is applied.

In a further embodiment different kinds of glyphs are used for mapping a multivariate data point to the glyph. The glyph could have different shapes, sizes and colors, or a combination thereof. So depending on the characteristic of the multivariate data point to be displayed a predetermined kind of glyph is mapped. By doing this, emphasis could be assigned to very relevant multivariate data points. Important points are desired to be monitored or fulfill a certain security pattern are displayed in a very conspicuous glyph. Multivariate data points having a smaller importance are mapped to inconspicuous glyphs having for instance small sizes or dark colors. Further only the attributes of interest of a multivariate data point should be mapped to the visualization dimensions of the glyph. Thus an effective filtering is achieved by not mapping unused attributes. An overloading of the display is prevented allowing a reliable monitoring of the arriving events.

According to a further embodiment the glyphs are displayed in a circular coordinate system. The coordinate system has the form of a radar screen. By assigning the attributes of the multivariate data points to a certain circular track, a first dimension could be displayed. A second dimension could be assigned to a certain angular sector. Further dimensions could be mapped to the brightness, size, colour, shape etcetera. The displaying of glyphs on the circular radar screen gives a good overview. For instance, the importance of multivariate data points could be mapped to the size of glyphs. So a first view on the circular radar screen provides directly the most relevant points. The position of these points provides further information.

In a further advantageous embodiment an event in an intrusion detection system is realized by the multivariate data points. As mentioned above in the area of computer networks security the amount of data to be monitored is very large. Therefore the use of the presented method is very suitable to visualize attributes of the events. By assigning or mapping the source IP, the alarm type and the time of arrival to the visualization dimensions, which could be displayed by the circular coordinate system an operator could get very easily an overview, if there are attacks or potential intrusions. In particular, the Source IP address will be mapped to the angular sector dimension. By dividing the circle into a plurality of sectors each sector will represent an individual source IP address or a range of source IP addresses. A further visualization dimension is represented with the circular tracks, wherein the alarm type of an event will be mapped to these circular tracks. Events shown by glyphs near the centre of the circular coordinate system indicate an alarm type having a high category, wherein events visualized by glyphs near the outer circumference of the circular coordinate system indicate lower alarm type category. By dividing the circle into a reasonable number of sectors and tracks the detectability of critical events, which could represent an intrusion or attack is facilitated. A further relevant attribute of an event is the time of arrival of a certain event. This attribute is assigned to the brightness. A continuous brightness dimension is used for the mapping of glyphs. For example an event represented by a glyph having a high (low) brightness value represents a young event. Depending on the used background of the monitoring device the mapping of the brightness should be adapted. In case of a white background the continuous brightness dimension should be negated, so the youngest events will assigned to lower brightness values. The kind of mapping depends on the user setting. Taking the first example, having young events with high brightness values, the calculation procedure has the form of a falling or decreasing function with increasing time values.

A further advantage will be achieved by limiting the range of time to be visualized. Depending on the user settings, the user can parameterize the calculation procedure for mapping the brightness values or he/she can interactively adapt the fuzzy membership function. By doing this, events lying within the last hour might be visualized only. By adapting the fuzzy membership function, the differentiating of different brightness values is improved, wherein a continuous brightness dimension is used which allows visualizing of more than only two brightness values as known from the prior art. Further the setting of lower and upper borders for the fuzzy membership function will spread the range to be visualized and thereby improve the ability to distinguish the events. The aspects of the present invention are also solved by a computer program.

Furthermore, the visualization of the multivariate data san be provided as a service. A customer can be billed for information that is derivable from the visualization of the multivariate. This can include the steps of deriving customer related information from displayed glyphs; providing the customer related information to the customer; and billing or charging the customer for the provided information. Thus, the presented method can be used to provide a useful service that helps customers to identify relevant intrusions and thereby making their systems more secure. Also, instead of providing the customer related information to the customer an immediate action could be initiated for protecting, e.g., the costumers network.

In the following various exemplary embodiments of the invention are described. Although the present invention is applicable in a broad variety of applications it will be described with the focus put on intrusion detection applications or security event monitoring applications. A further field for applying the invention might be an online analysis function for large amount of data. Before embodiments of the present invention are described, some basics, in accordance with the present invention, are addressed.

The invention deals with an improved visual approach for monitoring events triggered by one or more intrusion detection systems in a computer network. However, the inventive technique may also be useful for displaying other types of events, not just intrusion events.

The monitoring of events, in particular intrusion events, represents a task that requires high skill and attention from the monitoring staff. The reason for this is that a large fraction of the reported events are simply so-called “false” positive alarms. The challenge for the operator is therefore to spot those events that are associated with a real security problem. In order to identify such security events, the operator of the intrusion detection system is on the one hand interested in continuously watching a main characteristic of the incoming events and on the other hand to uncover interesting event patterns. Intrusion detection systems normally generate events provided with attribute values to supervise the network activities. These attributes are frequently called data dimensions.

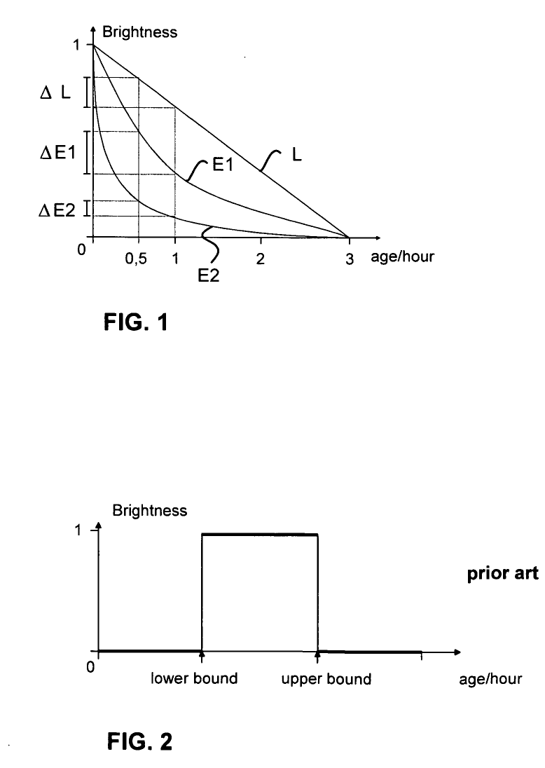

The invention might also be advantageously used in the HomeFinder mentioned above. The underlying problematic arising during comparing of brightness values of glyphs is illustrated in FIG. 1. The X-axis illustrates the time or the age of an event and the Y-axis illustrates the brightness value, wherein values between 0 and 1 could be assigned representing the minimum brightness (OFF) and the maximum brightness (ON). Values there between represent intermediate values. If the monitoring display contains events with an age between zero seconds and three hours then one possible way to map the age of an event to the brightness of the associated glyph is to use the linear L or exponential mapping functions E1 or E2. According to the mapping function L the brightness mapping of the glyphs is performed linearly. The mapping functions E1 and E2 show different exponential mapping functions. If the full time range is three hours as exemplary shown in FIG. 1 it is very difficult to tell apart events that arrived ½ h ago from events that arrived an hour ago, no matter whether a linear or an exponential mapping function is used, though ΔE1 is larger the closer the interesting differences are to the current time. If the linear mapping function L is used the ΔL will be constant for the same time period. In case of using the exponential mapping function E2, the ΔE2 will be smaller if the monitored time period is getting older.

Thus, if differences close to time=0 are more important than further out differences a well-selected logarithmic function might be appropriate to support the identification of the relevant differences. According to the mapping functions L, E1, E2 illustrated in FIG. 1, the exponential mapping function E2 will be the best choice.

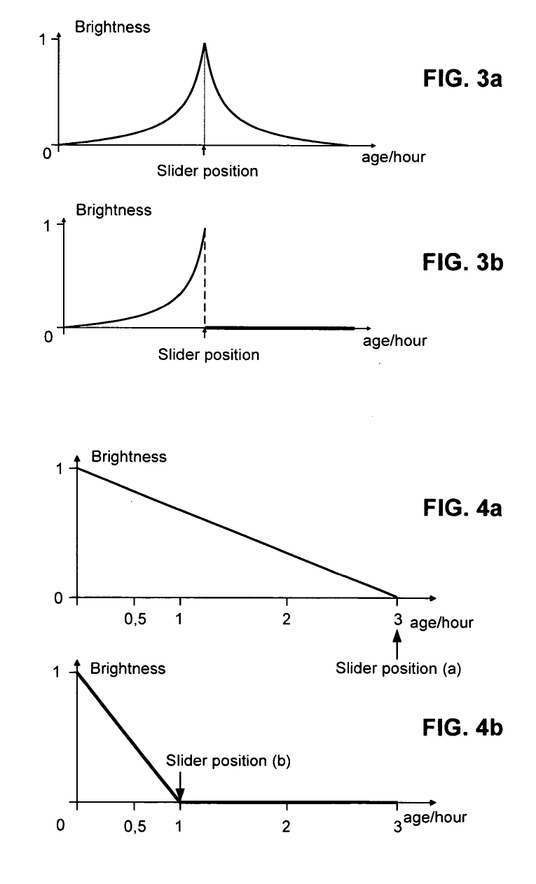

In some situations, however, it is not a priori clear what subinterval of values is most relevant and furthermore the lower bound of the relevant interval might not be zero. The use of a Boolean brightness function known from the prior art is illustrated in FIG. 2. The Boolean brightness function maps the brightness of all glyphs having an age within the specified interval to 1 to display the glyphs with full brightness and for events having age value outside the specified interval to 0. By mapping the brightness in that way valuable information is lost. According to the presented method, events are mapped after passing a pattern algorithm to a glyph. This glyph could have different shapes, sizes and colors. By determining the calculation procedure interactively using user settings or user specified parameters an individual mapping function could be created. FIGS. 3a and 3b show two examples for determining the calculation procedure of the brightness values for the glyphs. The user settings are realized as sliders. Depending on the position of a slider the mapping function for calculating the brightness value is changed.

The presented method has the advantage that it supports users to interactively select the interval of interest and provide comparability of events in the chosen interval using only the brightness visualization dimension. In contrary to the article of Shneiderman no Boolean brightness-mapping functions are used. A fuzzy membership function is used for determining the brightness of the associated glyph. According to the presented approach users cannot just specify an upper and/or lower bound of a desired interval, but could interactively specify one ore more parameters of the fuzzy membership function.

FIG. 3a shows a user-manipulatable interactive control, which specifies the center of a two-sided logarithmic membership function. By using that kind of mapping the events arrived at a certain point in time are visualized with the highest (lowest) brightness, wherein the events lying far away in time are mapped to lower (highest) brightness values (values in brackets indicate the brightness value if a white background is used for displaying glyphs). By changing the slider position the point in time having the highest (lowest) brightness values assigned could be changed.

FIG. 3b shows a combined Boolean and logarithmic function as mapping function. Using this combined mapping function for calculating the brightness values for glyphs events having arriving times lying after a certain point in time are not visualized, since they are mapped to the lowest (highest) brightness. Events lying very near before the point in time to be monitored and set by the slider are mapped to the highest brightness, wherein in direction of time back to zero the brightness is decreasing depending on the used logarithmic function for mapping the continuous brightness dimension.

In the domain of security event monitoring the presented method allows users to interactively modify the upper bound of a linear brightness-mapping function that describes the “newness” of an event. FIG. 4a shows that initially the interval of interest is the full time interval of all observed events. The user can then interactively move the upper bound of the interval of interest by moving the slider from position a to the position b, for example, to just focus on age differences in events that arrived in the last hour, as illustrated in FIG. 4b. This could be realized by simply changing the rise factor of the calculation procedure.

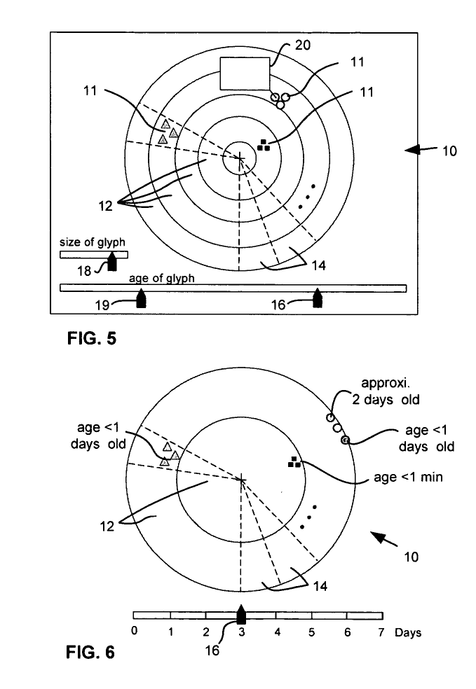

Referring to FIG. 5, a used monitoring console 10 is illustrated for monitoring events including the source-IP address, target-IP address, alarm type as classification of the identified network traffic and the arrival time. A circular coordinate system 10 is used having the form of a radar screen. The circular monitor 10 is divided having several circular tracks 12 and angular sectors 14. Further an age slider 16 is arranged for adjusting the point of time to be monitored. A further slider 18 could be used for adjusting the size of the glyphs 11. During pointing on a certain glyph 11 using a pointing device a detailed label 20 will appear having further attributes of the glyph in text form. For example the first occurrence, the most recent occurrence, the source and target IP, a signature, the number of occurrence and the customer could be displayed on this label 20.

In the following an example will be given for visualizing an arriving event. At first a pattern algorithm will check if the arriving event fits to a predetermined pattern. After being detected, the event should be visualized. Since not all attributes of an arriving event could be visualized and do not need to be visualized, the event will be mapped to a glyph. To make the example easy to understand, the kind of glyphs is not differentiated. The events will be mapped to a glyph having the form of a dot with a certain color. This glyph 11 includes two attributes which define its position on the circular monitor 10. Before being visualized a brightness value is mapped. The brightness dimension is used for visualizing the age of the event. In this example only one continuous brightness mapping function is used, for example, the brightness function shown in FIG. 4b. Depending on the position of the age slider 16 the point in time to be monitored is set, for example to monitor the events of the last hour. According the brightness mapping function shown in FIG. 4b the most recently events are mapped to the highest (lowest) brightness values, wherein events arrived about one hour ago are mapped to lower (highest) brightness values. The operator will see the current glyphs 11 with the highest (lowest) brightness.

The glyphs 11 near the centre of the circular monitor 10 are the most critical events, since their alarm type has a high priority. Glyphs 11 lying near the circumference of the circular monitor 10 have a lower alarm type category. As shown in FIG. 5 the displayed glyphs 11 are shown only within a small angular sector 14. This means the arriving events are coming from a very small range of Source IP addresses. Since the illustration of a white background is more suitable on paper, the mapping function shown in the figures should be inverted, since the lowest brightness values are best detectable, in contrary the highest brightness values could nearly not be noticed.

FIG. 6 shows an alternative circular monitor 10. The slider 16 is set at a position of 3 days. This will cause that events older than three days are shown with a high (low) brightness. The most recently events are shown having the lowest (highest) brightness. Depending on the background of the circular monitor 10 the brightness mapping is adjusted. If a black background is used glyphs having a low brightness could be recognized hardly. Glyphs having higher brightness values are more visible. In contrary if a white background is used for the circular monitor 10 the glyphs having a high brightness could be recognized hardly. Glyphs having lower brightness values are more visible.

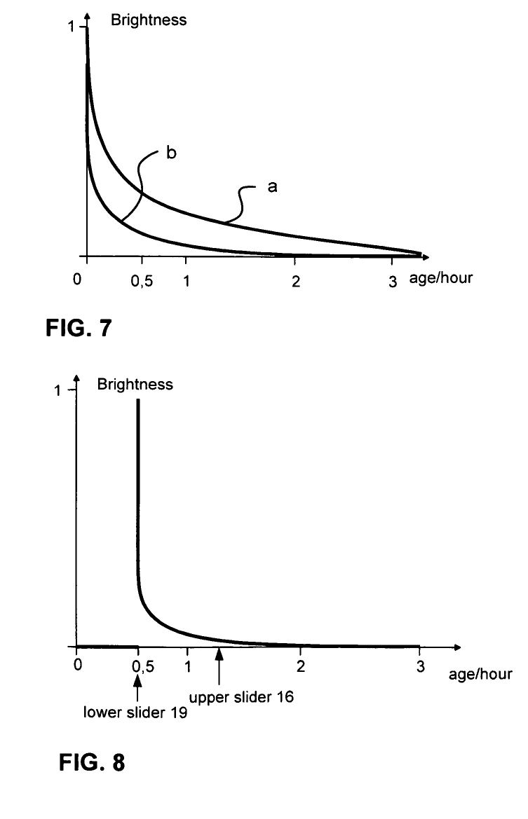

FIG. 7 illustrates an alternative implementation. Here the slider position a or b might specify the exponent of a logarithmic function in such a way that the brightness of the interactively specified event age is less than a given epsilon. So by moving the slider the asymptotic of the mapping function could be changed.

FIG. 8 illustrates the use of a second age slider 19, shown in FIG. 5, to parameterize the mapping of brightness values. So not only an upper bound (slider 16) of the interval of interest, but also a lower bound (slider 19) could be specified. This could, for example, be achieved by having a combined Boolean and logarithmic mapping function as in FIG. 8. Such combined mapping function could be realized by using a fuzzy membership function.

Using a continuous brightness mapping function which could be adopted interactively by the user the monitoring of security events will be improved. By adopting the mapping function in dependence on the security task the operator is able to recognize critical events more easily.

Variations described for the present invention can be realized in any combination desirable for each particular application. Thus particular limitations, and/or embodiment enhancements described herein, which may have particular advantages to the particular application need not be used for all applications. Also, not all limitations need be implemented in methods, systems and/or apparatus including one or more concepts of the present invention. The invention also includes apparatus for implementing steps of method of this invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method for visualization of multivariate data being provided with attributes comprising the steps of:
mapping a multivariate data point to a glyph;
calculating a brightness value for the glyph by mapping a continuous data dimension to the glyph; and
displaying the glyph based on the calculated brightness value.

2. A method according to claim 1, wherein the step of calculating a brightness value comprises determining of a calculation procedure for calculating the brightness value for the glyph, wherein user settings are used to parameterize the calculation procedure interactively.

3. A method according to claim 2 further comprising:
using a fuzzy algorithm for a calculation of the brightness value for the glyph;
adjusting at least one parameter (t) of a used fuzzy membership function by s user interactively.

4. A method according to claim 1, further comprising:
mapping the multivariate data point to different kinds of glyphs depending on the characteristic of the multivariate data point, the glyph comprising one of different shapes, colours, sizes, and a combination thereof;
mapping an attribute of interest to a visualization dimension of the glyph.

5. A method according to claim 1, further comprising:
providing the displaying of glyphs in a circular coordinate system comprising a plurality of circular tracks and angular sectors.

6. A method according to claim 1, further comprising:
representing the multivariate data point by an event in an intrusion detection system,
each event being provided with attributes including a source IP address, alarm type and/or time of arrival.

7. A method according to claim 6, further comprising:
mapping the source IP address to the angular sector dimension;
mapping the alarm type to the circular track dimension;
mapping the time of arrival to a brightness value, wherein the time period to be monitored is adjusted by user settings to adapt the calculation procedure of the brightness value.

8. A computer program comprising program code for performing the method of claim 1, when said program is run on a computer.

9. A computer program product stored on a computer usable medium, comprising computer readable program code for causing a computer to perform all the steps of the method of claim 1.

10. A system for displaying multivariate data comprising means to perform the steps of the method as claimed in claim 1.

11. A method of billing a customer for information derivable from the visualization of multivariate data according to the steps of the method as claimed in claim 1, comprising:
deriving customer related information from the displayed glyphs;
providing the customer related information to the customer; and
billing the customer for the provided information.

12. An apparatus for visualization of multivariate data being provided with attributes comprising:
means for mapping a multivariate data point to a glyph;
means for calculating a brightness value for the glyph by mapping a continuous data dimension to the glyph; and
means for displaying the glyph based on the calculated brightness value.

13. An apparatus according to claim 13, wherein the means for calculating a brightness value comprises means for determining of a calculation procedure for calculating the brightness value for the glyph, wherein user settings are used to parameterize the calculation procedure interactively.

14. An apparatus according to claim 14 further comprising:
means for using a fuzzy algorithm for a calculation of the brightness value for the glyph;
means for adjusting at least one parameter (t) of a used fuzzy membership function by s user interactively.

15. An apparatus according to claim 13, further comprising:
means for mapping the multivariate data point to different kinds of glyphs depending on the characteristic of the multivariate data point, the glyph comprising one of different shapes, colours, sizes, and a combination thereof;
means for mapping an attribute of interest to a visualization dimension of the glyph.

16. An article of manufacture comprising a computer usable medium having computer readable program code means embodied therein for causing visualization of multivariate data being provided with attributes, the computer readable program code means in said article of manufacture comprising computer readable program code means for causing a computer to effect the steps of claim 1.

17. An article of manufacture comprising a computer usable medium having computer readable program code means embodied therein for causing billing of a customer for information derivable from the visualization of multivariate data, the computer readable program code means in said article of manufacture comprising computer readable program code means for causing a computer to effect the steps of claim 11.

18. A program storage device readable by machine, tangibly embodying a program of instructions executable by the machine to perform method steps for visualization of multivariate data being provided with attributes, said method steps comprising the steps of claim 1.

19. A program storage device readable by machine, tangibly embodying a program of instructions executable by the machine to perform method steps for billing a customer for information derivable from the visualization of multivariate data, said method steps comprising the steps of claim 11.

20. A computer program product comprising a computer usable medium having computer readable program code means embodied therein for causing visualization of multivariate data being provided with attributes, the computer readable program code means in said computer program product comprising computer readable program code means for causing a computer to effect the functions of claim 12.
